(19) United States
(12) Patent Application Publication
(10) Pub. No.: US 2008/0219241 A1
(43) Pub. Date: Sep. 11, 2008

(54) Subscriber access authorization

(75) Inventors: Anu Leinonen, Tampere (FI); Kalle Tammi, Nokia (FI); Son Phan-Anh, Budapest (HU)

Correspondence Address: HARRINGTON & SMITH, PC, 4 RESEARCH DRIVE, SHELTON, CT, 06484-6212, US

(73) Assignee: Nokia Corporation

(21) Appl. No.: 11/716,445

(22) Filed: Mar. 9, 2007

(51) Int. Cl. H04L 12/66

(52) U.S. Cl. 370/352

(57) ABSTRACT

A method for registering a session initiation protocol (SIP) client to an internet protocol multimedia subsystem (IMS), in which a SIP client having a given IP address, public identity and private identity sends a registration request to a session border controller (SBC) for registering the public identity to the IMS, the SBC responsively causes an authorization request to be sent to another network entity in the IMS, the authorization request indicating the IP address of the SIP client and a private identity, the another network entity obtaining from an LDAP/AAA server a reference address based on the private identity and deciding whether to allow the authorization of the public identity to the IMS based on the correspondence between the reference address and the IP address of the SIP client.

### FIELD OF THE INVENTION

The present invention generally relates to subscriber access authorization. The invention relates particularly, though not exclusively, to access authorization of broadband connection subscribers to Internet Protocol (IP) Multimedia Subsystem (IMS).

### BACKGROUND OF THE INVENTION

Presently, various IP based communications services are provided to Internet users. Typically, services are provided to users with a password based authorization. The password may be provided manually by the user or in some cases the password is provided automatically by a user's terminal or terminal adapter. For instance, there are commercially available Voice Over IP adapters to be plugged into an Ethernet socket and which when powered will acquire an IP address and register to a service provider using a built-in authorization, with charging being carried out according to a contract with the service provider. Such adapters typically connect to the Internet virtually anywhere in the world and yet provide calls to a “home country” as domestic calls. The advantage of connecting legacy analog devices such as telephones and facsimile devices is that these devices are very commonly available and generally perceived as very convenient to use.

Whilst some service providers are tempted by allowing a user to tap into the Internet and place calls from anywhere as from home, there are also established telecommunications operators who should maintain their existing network infrastructure in the tightening competition brought about by mobile communications and Internet based VoIP services. It is also sometimes desirable to prevent the transfer of a subscription elsewhere for other reasons such as to avoid the need of an employer to pay for the personal calls of employees. Moreover, by binding the VoIP services to a given broadband subscription, the service provider may be relatively placed to assert a fixed term contract and to thereby benefit the customer with possible subsidies.

The network attachment and admission subsystem (NASS) bundled (NBA) specified by the European telecommunications standards institute (ETSI) telecoms & internet converged services & protocols for advanced network (TISPAN) provides a mechanism to restrict IMS access of an IMS client so that the access is only allowed from a pre-defined location. However, in the early interim deployment phase some networks deploy so called session border controller (SBC) devices for broadband access which work in back-to-back user-agent (B2BUA) mode and not in proxy mode as a standard proxy call session control function (P-CSCF) and which also lack standard NBA support.

### SUMMARY

According to a first aspect of the invention there is provided a method in an internet protocol multimedia subsystem (IMS) interacting with session initiation protocol (SIP) clients, wherein each SIP client has an internet protocol (IP) address, private identity and a public identity corresponding to the private identity, comprising:
receiving a SIP registration request from a SIP client for a given public identity, the registration request comprising the client's IP address and the client's public identity;
modifying the SIP registration request by adding to the SIP registration request a SIP header comprising the IP address of the SIP client;
sending to a call session control function (CSCF) entity the modified SIP registration request within the IMS;
receiving the modified SIP registration request by the CSCF;
obtaining the private identity and identifying the presence of the SIP header with the client's IP address in the registration request by the CSCF; and
responsive to identifying the presence of the client's IP address in the SIP header of the SIP registration request, the CSCF causing:
   obtaining a reference address from a user database based on the private identity;
   comparing said client's IP address with the reference address; and
   allowing registration of the public identity to the IMS if the reference address corresponds to the IP address and otherwise refusing the registration.

Advantageously, an IMS subscription may be allowed to access an IMS-based service such as VoIP only from a predetermined location. Further, after successful attachment to a broadband access, a SIP client hosted at a certain location may be allocated a given IP address. Therefore, the restriction to allow access to a given one or more IMS based services from a certain location may correspond to allowing access to a given service only from the given IP address.

According to a second aspect of the invention there is provided a method in a session border controller (SBC) acting as an outbound proxy for an internet protocol multimedia subsystem (IMS), comprising:
interacting with session initiation protocol (SIP) clients and with a call session control function (CSCF) server, each of the clients being assigned an internet protocol (IP) address; a private identity; and a public identity;
receiving a SIP registration request from a SIP client for a given public identity, the registration request comprising the client's IP address and the client's public identity;
modifying the SIP registration request to include the IP address of the SIP client in a SIP header; and
sending to the CSCF server the modified SIP registration request including the IP address in the SIP header in order to cause verifying the authority of the SIP client to register the public identity to the IMS based on a reference address in a user database accessible to the IMS.

The SBC may be configured to include the IP address in the SIP header of said request only if the SBC detects that the received SIP registration request originates from a broadband subscription. Alternatively, if the SBC is unable to detect whether the received registration request is sent from broadband subscriptions or if the SBC is not configured to attempt said detecting, the SBC may always respond to received registration requests by sending to the CSCF server a registration request that has the SIP header including the IP address of the SIP client.

The method may further comprise causing the CSCF server to verify the authority of the SIP client to register the public identity to the IMS based on the reference address. Alternatively, the IMS may further comprise a home subscriber server (HSS) and the method may further comprise causing via the CSCF the HSS to verify the authority of the SIP client to register the public identity to the IMS based on a reference address in a user database. The user database may be directly or indirectly accessible to the HSS.

Advantageously, by including the IP address of the SIP client in the SIP header of the SIP registration request, the SBC may indirectly verify the authority of the SIP client to register its public identity by having verified that the IP address of the client corresponds is a permissible address according to the user database. Hence, it may be expected that a SIP service provider hosting the database permits the use of a SIP service by the SIP client and it is allowable to register the public identity to the IMS.

The SBC may be configured to act as an outbound proxy for the SIP client. The SBC may be configured to serve only location-base restricted SIP clients and thereby to always insert the SIP header including the IP address of the SIP client in the SIP registration request.

The SBC may be configured to act as an outbound proxy for the SIP client and to serve also other than location-base restricted SIP clients so that the inserting the SIP header including the IP address of the SIP client is configured into the outbound proxy.

The outbound proxy may be configured to operate in a Back-To-Back User Agent (B2BUA) mode.

The outbound proxy may be configured to send the modified SIP registration request to the CSCF server in case that a location-base restriction applies to the SIP client.

The CSCF server may act as a proxy call session control function (P-CSCF) server. The CSCF server may also act as a serving CSCF (S-CSCF) or as an Interrogating CSCF (I-CSCF) server.

The user database may be either of an authentication, authorization, and accounting (AAA) server; and a lightweight directory access protocol (LDAP) server.

According to a third aspect of the invention there is provided a method in a call session control function (CSCF) entity for an internet protocol multimedia subsystem (IMS) that comprises a session border controller (SBC) for interacting with session initiation protocol (SIP) clients, each client having an internet protocol address, a private identity and a public identity, the method comprising:
receiving from the SBC a modified SIP registration request indicative of a request of a SIP client to register its public identity to the IMS, the modified SIP registration request indicating the public identity and including the IP address of the SIP client in a SIP header;
identifying the presence of the client's IP address in the SIP header of the modified SIP registration request; and responsive to the identifying of the presence of the client's IP address in the SIP header of the modified SIP registration request:
obtaining the private identity corresponding to the public identity;
causing obtaining of a reference address from a user database based on the private identity; and
causing comparing of said client's IP address with the reference address and if the IP address corresponds to the reference address, proceeding registration of the public identity to the IMS and if the network address does not correspond to the reference address, refusing the registration of the public identity to the IMS.

The CSCF server may be a serving CSCF (S-CSCF) server configured to obtain the reference address from a home subscriber server (HSS) by sending to the HSS a multimedia authentication request (MAR) indicative of the private identity and of the IP address of the SIP client; and responsively receiving a multimedia authentication answer (MAA) containing the reference address.

In case that the network entity is the S-CSCF, the HSS may be seen configured to receive an multimedia authorization request (MAR) indicative of a private identity associated to a SIP client; to obtain from a subscriber database for a reference address associated with the private identity; and to send a multimedia authorization answer (MAA) corresponding to the MAR and containing the reference address to allow authorization of the SIP client subject to the reference address corresponding with the IP address of the SIP client.

The HSS may be configured to detect a particular parameter in the subscriber database that causes the HSS to provide the S-CSCF with the reference address. Correspondingly, the S-CSCF may be seen configured to:
receive a modified SIP registration request for a SIP client, including a SIP header containing the IP address of the client;
sending to the HSS a MAR indicative of the private identity but not indicative of the IP address of the SIP client;
receiving a multimedia authentication answer (MAA) containing the reference address; and
responsive to the modified SIP registration request containing the SIP header with the IP address of the client, comparing the IP address with the reference address to determine whether the SIP client should be allowed register its public identity to the IMS.

The CSCF may be an interrogating CSCF (I-CSSF) and configured to send to a home subscriber server (HSS) a user authorization request (UAR) including the private identity and the IP address of the client in order to cause the HSS to obtain from the subscriber database a reference address corresponding to the IP address and to compare the reference address to the client's IP address; and responsively to receive from the HSS a rejection message if the IP address does not match with the reference address.

According to a fourth aspect of the invention there is provided a method in a home subscriber server for an internet protocol multimedia subsystem (IMS), comprising:
receiving a user authorization request (UAR) within the IMS indicative of a request of a SIP client to register its public identity to the IMS, the public identity corresponding to a private identity and the UAR including the private identity and an IP address of the SIP client;
identifying the presence of the client's IP address in the UAR;
obtaining the private identity;
obtaining a reference address from a user database based on the private identity; and
comparing said client's IP address with the reference address and if the IP address corresponds to the reference address, proceeding registration of the public identity to the IMS and if the network address does not correspond to the reference address, refusing the registration of the public identity to the IMS.

The HSS may be configured to receive a registration request from an interrogating CSCF (I-CSCF).

The UAR may be compliant with Diameter protocol.

The HSS may be further configured to obtain the reference address from a user database that maintains mapping between allocated addresses and private identities of different SIP clients.

According to a fifth aspect of the invention there is provided an internet protocol multimedia subsystem (IMS) for interacting with session initiation protocol (SIP) clients, wherein each SIP client has an internet protocol (IP) address, private identity and a public identity corresponding to the private identity, the IMS comprising:
a call session control function (CSCF);
a session border controller (SBC) configured to receive a SIP registration request from a SIP client for a given public identity, the registration request comprising the client's IP address and the client's public identity; the SBC being further configured to:
modify the SIP registration request by adding to the SIP registration request a SIP header comprising the IP address of the SIP client;
send to the CSCF the modified SIP registration request; the CSCF being configured to:
receive the modified SIP registration request from the SBC;
obtain the private identity and identifying the presence of the SIP header with the client's IP address in the registration request; and
cause, responsive to identifying the presence of the client's IP address in the SIP header of the SIP registration request:
   obtaining a reference address from a user database based on the private identity;
   comparing said client's IP address with the reference address; and
   allowing registration of the public identity to the IMS if the reference address corresponds to the IP address and otherwise refusing the registration.

According to a sixth aspect of the invention there is provided a session border controller (SBC) configured to act as an outbound proxy for an internet protocol multimedia subsystem (IMS), comprising:
an interface configured to interact with session initiation protocol (SIP) clients and with a call session control function (CSCF) server, each of the clients being assigned an internet protocol (IP) address; a private identity; and at a public identity;
wherein the interface is further configured to receive a SIP registration request from a SIP client for a given public identity, the registration request comprising the client's IP address and the client's public identity; and
an output for sending to the CSCF server a SIP registration request including the IP address used by SIP client in a SIP header in order to cause verifying the authority of the SIP client to register the public identity to the IMS based on a reference address in a user database accessible to the IMS.

The SBC may be configured to include the IP address in the SIP header of said request only if the SBC detects that the received SIP registration request originates from a broadband subscription. Alternatively, the SBC may be configured so that if the SBC is unable to detect whether the received registration request is sent from broadband subscriptions or if the SBC is configured not to attempt said detecting, the SBC always responds to received registration requests by sending to the CSCF server a registration request that has the SIP header including the IP address of the SIP client.

The SCB may further be configured to cause the CSCF server to verify the authority of the SIP client to register the public identity to the IMS based on the reference address.

The SBC may be configured to act as an outbound proxy for the SIP client. The SBC may be configured to serve only location-base restricted SIP clients and thereby to always insert the SIP header including the IP address of the SIP client in the SIP registration request.

The SBC may be configured to act as an outbound proxy for the SIP client and to serve also other than location-base restricted SIP clients so that the inserting the SIP header including the IP address of the SIP client is configured into the outbound proxy.

The outbound proxy may be configured to operate in a Back-To-Back User Agent (B2BUA) mode.

The outbound proxy may be configured to send the IP address of the SIP client to the CSCF server in the modified SIP registration request only in case that a location-base restriction applies to the SIP client.

According to a seventh aspect of the invention there is provided a call session control function (CSCF) server for an internet protocol multimedia subsystem (IMS) that comprises a session border controller (SBC) for interacting with session initiation protocol (SIP) clients, each client having an internet protocol address, a private identity and a public identity, the CSCF server comprising:
an input configured to receive from the SBC a modified SIP registration request indicative of a request of a SIP client to register its public identity to the IMS, the modified SIP registration request indicating the public identity and including the IP address of the SIP client in a SIP header; and
a processor configured to:
   identifying the presence of the client's IP address in the SIP header of the modified SIP registration request; and responsive to the identifying of the presence of the client's IP address in the SIP header of the modified SIP registration request:
   obtaining the private identity corresponding to the public identity;
   causing obtaining of a reference address from a user database based on the private identity; and
   causing comparing of said client's IP address with the reference address and if the IP address corresponds to the reference address, proceeding registration of the public identity to the IMS and if the network address does not correspond to the reference address, refusing the registration of the public identity to the IMS.

The CSCF server may be a serving CSCF (S-CSCF) server configured to obtain the reference address from a home subscriber server (HSS) by sending to the HSS a multimedia authentication request (MAR) indicative of the private identity; and responsively receiving a multimedia authentication answer (MAA) containing the reference address.

The CSCF server may be configured to operate both as an interrogating CSCF (I-CSCF) and as a serving CSCF (S-CSCF) server.

According to an eighth aspect of the invention there is provided a home subscriber server for an internet protocol multimedia subsystem (IMS), comprising:
an input configured to receive a user authorization request (UAR) within the IMS indicative of a request of a SIP client to register its public identity to the IMS, the public identity corresponding to a private identity and the UAR including the private identity and an IP address of the SIP client;
a processor configured to:
   identifying the presence of the client's IP address in the UAR;
   obtaining the private identity;
   obtaining a reference address from a user database based on the private identity; and
   comparing said client's IP address with the reference address and if the IP address corresponds to the reference address, proceeding registration of the public identity to the IMS and if the network address does not correspond to the reference address, refusing the registration of the public identity to the IMS.

The HSS may be configured to receive a registration request from an interrogating CSCF (I-CSCF).

The UAR may be compliant with Diameter protocol.

The HSS may be further configured to obtain the reference address from a user database that maintains mapping between allocated addresses and private identities of different SIP clients.

According to a ninth aspect of the invention there is provided a home subscriber server for an internet protocol multimedia subsystem (IMS) comprising a call session control function (CSCF) server, comprising:
an input configured to receive from the CSCF server a multimedia authorization request (MAR) indicative of a request of a SIP client to register its public identity to the IMS, the public identity corresponding to a private identity and the MAR including the private identity and an IP address of the SIP client;
a processor configured to:
   check whether the private identity is associated with a location restriction;
   obtain a reference address from a user database based on the private identity responsive to detecting that a location restriction is associated with the private identity; and
   send a multimedia authorization answer (MAA) to the CSCF including the reference address corresponding to the private identity.

According to a tenth aspect of the invention there is provided a computer program configured to cause a session border controller to implement the method according to the second aspect of the invention.

According to an eleventh aspect of the invention there is provided a computer program configured to cause a network entity to implement the method according to the third aspect of the invention.

According to a twelfth aspect of the invention there is provided a computer program configured to cause a home subscriber server to implement the method according to the fourth aspect of the invention.

According to a thirteenth aspect of the invention there is provided a memory medium storing a computer program according to any of the ninth to eleventh aspect of the invention.

According to a fourteenth aspect of the invention there is provided a system comprising any elements according to the invention.

According to a fifteenth aspect of the invention there is provided a session border controller (SBC) configured to act as an outbound proxy for an internet protocol multimedia subsystem (IMS), comprising:
means for interacting with session initiation protocol (SIP) clients and with a call session control function (CSCF) server, each of the clients being assigned an internet protocol (IP) address; a private identity; and a public identity;
means for receiving a SIP registration request from a SIP client for a given public identity, the registration request comprising the client's IP address and the client's public identity; and
means for sending to the CSCF server a SIP registration request including the IP address used by SIP client in a SIP header in order to cause verifying the authority of the SIP client to register the public identity to the IMS based on a reference address in a user database accessible to the IMS.

Various embodiments of the present invention have been illustrated only with reference to certain aspects of the invention. It should be appreciated that corresponding embodiments may apply to other aspects as well.

### BRIEF DESCRIPTION OF THE DRAWINGS

The invention will be described, by way of example only, with reference to the accompanying drawings, in which:

FIG. 1 shows a schematic picture of a system according to an embodiment of the invention;

FIG. 2 shows a block diagram of a server according to an embodiment of the invention;

FIG. 3 shows a block diagram of a terminal of FIG. 1;

FIG. 4 shows main signaling according to an embodiment of the invention; and

FIG. 5 shows main signaling according to another embodiment of the invention.

### DETAILED DESCRIPTION

In the following description, line numbers denote like elements.

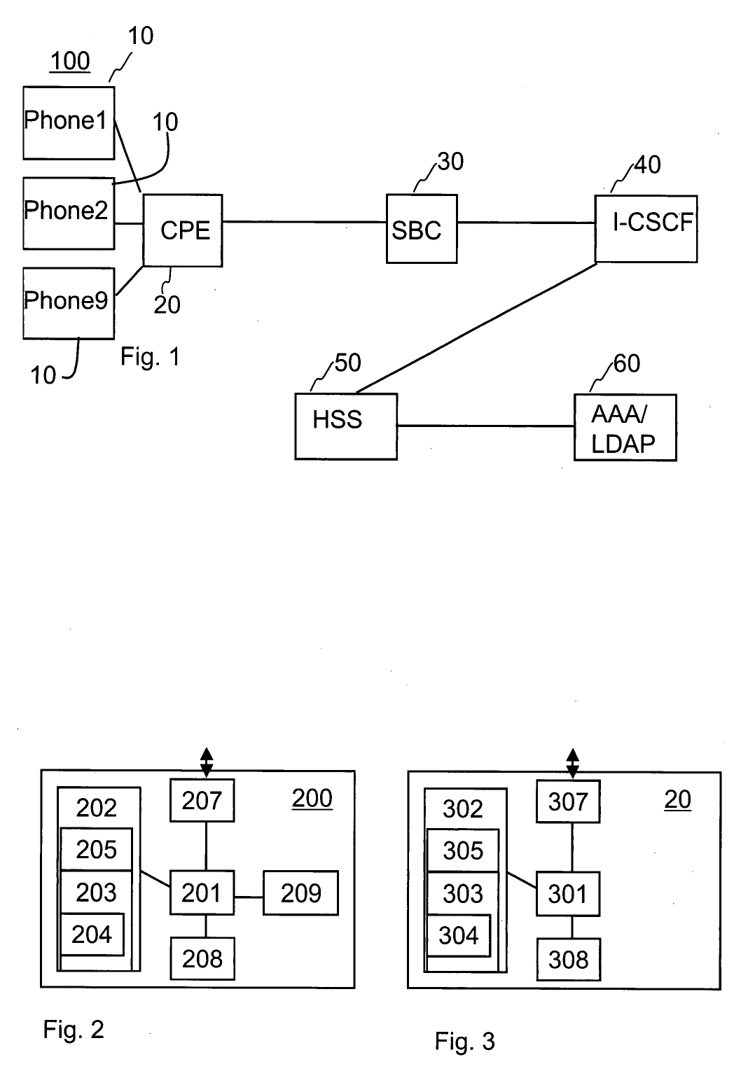

FIG. 1 shows a schematic picture of a system 100 according to an embodiment of the invention. The system comprises customer premises equipment (CPE) 20 that is typically configured to perform DSL modem functions. The CPE 20 has a number of ports for different customer devices such as Voice over Internet Protocol (IP) or VoIP devices 10. The VoIP devices are typically telephones or facsimile devices. Each or at least some portion of the ports is assigned with a unique Multiple Subscriber Number (MSN). The CPE is configured to connect via customers' telephone lines to operator's broadband access that is connected to an IP multimedia subsystem IMS. Hence, the CPE 20 allows the VoIP devices 10 to act as Session Initiation Protocol (SIP) clients to the IMS. The broadband packet data network comprises a session border controller (SBC) 30, a call session control function (CSCF) possibly distributed among different servers, here represented by an Interrogating CSCF (I-CSCF) 40, a home subscriber server 50 and a subscriber database 60 such as an authentication, authorization, and accounting (AAA) server or a lightweight directory access protocol (LDAP) server. As the normal structure of the SBC 30, CSCF 40, HSS 50 and subscriber database 60 is well known, the structure is not further described herein. It suffices to say that these servers may each be distributed among two or more physical servers or combined with another server to a common physical server.

FIG. 2 shows a block diagram of a server 200 configured to operate as any server described within this document according to an embodiment of the invention. The server 200 comprises a memory 202 including a persistent memory 203 configured to store computer program code 204. The server 200 further comprises a processor 201 for controlling the operation of the server using the computer program code 204, a work memory 205 for running the computer program code 204 by the processor 201, a communication port 207 for communicating with other network elements, an optional user interface 208 including data input and output circuitry, and a database 209. The processor 201 is typically a master control unit MCU. Alternatively, the processor may be a microprocessor, a digital signal processor, an application specific integrated circuit, a field programmable gate array, a microcontroller or a combination of such elements.

FIG. 3 shows a block diagram of the CPE 20 of FIG. 1. The CPE 20 comprises a memory 302 including a persistent memory 303 configured to store computer program code 304 and the CPE's private identity. The persistent memory 303 further stores other data to be maintained in the CPE such as a password in one embodiment of the invention. The CPE 20 further comprises a processor 301 for controlling the operation of the CPE 20 using the computer program code 304, a work memory 305 for running the computer program code 304 by the processor 301, a communication unit 307 for communicating with the AP 20 and a control interface 308. The control interface 308 typically comprises a local area network (LAN) port and a browser server configured to enable connecting a computer to the CPE and viewing and changing different settings of the CPE 20 with an ordinary Internet browser. The processor 301 is typically a master control unit MCU. Alternatively, the processor may be a microprocessor, a digital signal processor, an application specific integrated circuit, a field programmable gate array, a microcontroller or a combination of such elements. The CPE 20 is typically configured to operate as a modem using an asymmetric digital subscriber line (ADSL) or symmetric digital subscriber line (SDSL). The communication unit 307 is configured to communicate accordingly. Further, the CPE is typically configured to operate as a network address translator (NAT) and/or as a firewall for devices further connected to the CPE 20. The CPE 20 may also operate as a switch or router to enable connecting one or more packet data devices that gain access to the packet data network via the communication unit 307. The CPE 20 is configured to derive a public identity based on its private identity.

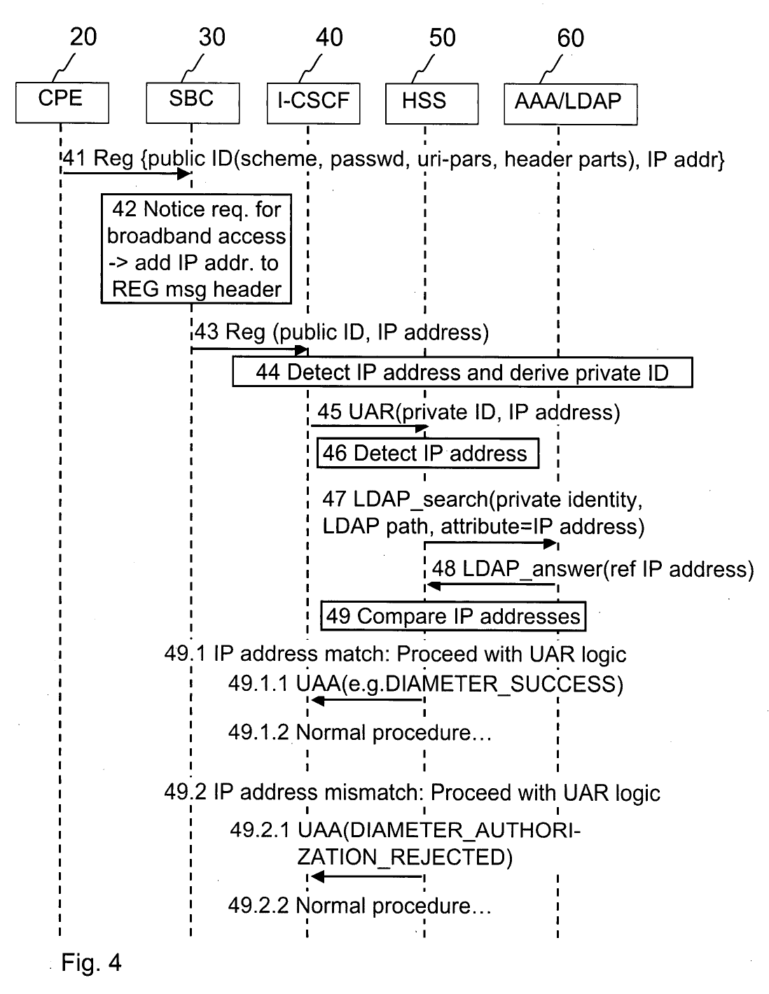

FIG. 4 shows main signaling according to an embodiment of the invention. When the CPE 20 needs to register an attached VoIP device or more generally a SIP client to the IMS, the CPE first normally obtains an IP address using any known method such as using dynamic host configuration protocol (DHCP) unless the CPE has a fixed IP address. The CPE maintains a private identity (ID). The registration process basically starts by the CPE 20 sending 41 to the SBC 30 a registration message with its IP address normally in an IP header and with its public identity corresponding to the private identity. The SBC 30 checks 42 the source IP address header field of the IP packet or packets 41 received from SIP client and reports it to the I-CSCF in a specific field of a SIP header and the public identity typically in another SIP header, if the registration of the SIP client is subject to a location based restriction, as is described with further detail at the end of this description. The specific field used in the registration message may still be simply the via header field, but for better accuracy another additional header field may be used. On receiving the registration message, the I-CSCF 40 derives a private identity corresponding to the public identity and checks 44 the header field of the registration message and on detecting the IP address in a specific header the I-CSCF 40 sends a UAR 45 to the HSS 50, including in a new attribute value pair (AVP) where the address of the CPE 20 is carried.

The HSS 50, responsive to receiving the UAR 45, checks 46 the AVPs of the UAR and on detecting the CPE's IP address in a new AVP, the HSS 50 performs a subscriber database query 47. The query is typically performed by sending to the subscriber database 60 a database query message 48 such as an LDAP_Search message including the private ID of the CPE 20. The query message typically contains search parameters such as LDAP path and as a result an attribute IP address, that is, indication that IP address is being fetched corresponding to the search criterion (private ID). The subscriber database 60 responsively sends a query answer 48 such as an LDAP_answer message, with a reference IP address that is an address associated with the private ID of the CPE. Based on the IP address received from the I-CSCF and on the reference address received from the subscriber database, it is possible to determine by comparison 49 whether the registration message 41 has been received through that packet data network connection that has been defined by the operator to be used in association with the service or more accurately service and identity (such as phone number). If there is a match, that is the addresses received from the I-CSCF 20 and from the subscriber database 60 correspond to each other, then it is proceeded 49.1 in accordance with normal UAR logic. A user authorization answer (UAA) is sent from the HSS 50 to the I-CSCF 40 as a success message (if Diameter protocol is used) and the normal registration process continues 49.2 thereafter. However, if it is detected 49.2 that the addresses mismatch, then a corresponding authorization failure indication is sent from the HSS 50 to the I-CSCF 40, such as an UAA(Diameter_authorization_rejected) message and a normal procedure 49.2.2 after failed authorization would follow.

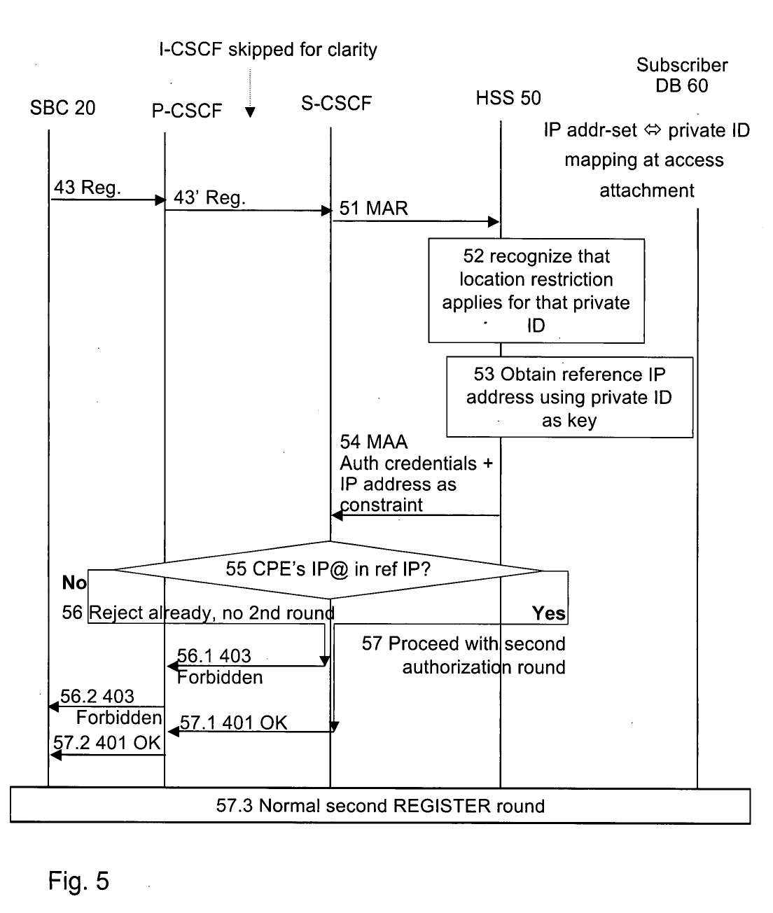

FIG. 5 shows main signaling according to another embodiment of the invention. In contrast to FIG. 4, the CPE has been suppressed in sake of simplicity. Instead of showing the I-CSCF, FIG. 5 illustrates a proxy CSCF (P-CSCF) and a serving CSCF (S-CSCF) which operate as is known from the IMS. Responsive to registration request from the CPE 20, the SBC passes a registration request 43 via the P-CSCF as a forwarded (that is as a modified) registration request 43′ to the S-CSCF which then sends a multimedia authorization request MAR 51 to the HSS 50. In contrast to the embodiment illustrated in FIG. 4, here the HSS is not provided with the CPE's IP address. Instead, the HSS recognizes 52 based on a parameter in the HSS DB (private identity specific parameter) that a location based restriction applies to the CPE 20 and obtains 53 a reference IP address from the subscriber database 60. This obtaining may use messages 47 and 48 described in connection with FIG. 4. The HSS then provides the S-CSCF with an MAA 54 containing authentication credentials and received IP address for use as reference address. The MAA 54 may thus contain a new AVP for carrying the reference address as a framed (IP) address. It is then an intervening network entity, here the S-CSCF, which will determine 55 whether the CPE 20 from which the registration request had originated is associated in the subscriber database 60 with the address that was identified in the registration message 43 (and 43′). If the determination 55 is negative, then the registration process continues by rejection 56 and a rejection message 56.1 is sent from the S-CSCF (typically SIP 403 Forbidden) to the P-CSCF and further onwards as forwarded rejection message 56.2 to the SBC 20 and finally to the CPE (not shown). In contrast, if the determination 55 is positive, the registration proceeds 57 and in an embodiment of the invention a second registration round is started before completing the registration process. A positive authorization message 57.1 (typically SIP 401 Unauthorized) is sent from the S-CSCF to the P-CSCF and onwards 57.2 to the SBC 20. A second registration round may next be started 57.3 following the successful determination 55.

In the preceding paragraph an embodiment was disclosed in which the MAR does not contain the IP address of the SIP client. Alternatively, the MAR is adapted to carry the SIP client's IP address along with its usual data and the HSS may recognize that a location based restriction applies to the SIP client from the presence of the IP address in the MAR, from a parameter associated with the SIP client's private identity, or from both the parameter and the presence of the IP address in the MAR.

It should further be understood that the MAR normally contains both the private identity and the public identity of the SIP client. It is a question of implementation whether the reference address is obtained from the subscriber database using the private identity as a query term or using the public identity, as both identities are unique and belong only to one subscription in the HSS.

In an embodiment of the invention, the SBC initiates checking of the location (or IP address) of the SIP client (or CPE 20) only if it can deduce that the SIP client resides within a given data communication network. In different embodiments, this deduction is based on:
Separate SBCs serve different access network(s) so that a given SBC always inserts in a new SIP header the IP address of the CPE 20.
A common SBC serves different networks A and B concurrently and new header is only added for requests coming from network A. To detect whether the request is coming from network A or from B, the following techniques are provided amongst others:
   There are different IP interfaces (e.g. different LAN adapters or different virtual interfaces in a common LAN adapter) in the SBC, one being configured for connection to network A, another being configured for network B.
   Different IP address ranges are allocated for networks A and B so that the SBC deduces the source network base on the IP address.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

We claim:

1. A method in an internet protocol multimedia subsystem (IMS) interacting with session initiation protocol (SIP) clients, wherein each SIP client has an internet protocol (IP) address, private identity and a public identity corresponding to the private identity, comprising:
receiving a SIP registration request from a SIP client for a given public identity, the registration request comprising the client's IP address and the client's public identity;
modifying the SIP registration request by adding to the SIP registration request a SIP header comprising the IP address of the SIP client;
sending to a call session control function (CSCF) entity the modified SIP registration request within the IMS;
receiving the modified SIP registration request by the CSCF;
obtaining the private identity and identifying the presence of the SIP header with the client's IP address in the registration request by the CSCF; and
responsive to identifying the presence of the client's IP address in the SIP header of the SIP registration request, the CSCF causing:
obtaining a reference address from a user database based on the private identity;
comparing said client's IP address with the reference address; and
allowing registration of the public identity to the IMS if the reference address corresponds to the IP address and otherwise refusing the registration.

2. A method in a session border controller (SBC) acting as an outbound proxy for an internet protocol multimedia subsystem (IMS), comprising:
interacting with session initiation protocol (SIP) clients and with a call session control function (CSCF) server, each of the clients being assigned an internet protocol (IP) address; a private identity; and a public identity;
receiving a SIP registration request from a SIP client for a given public identity, the registration request comprising the client's IP address and the client's public identity;
modifying the SIP registration request to include the IP address of the SIP client in a SIP header; and
sending to the CSCF server the modified SIP registration request including the IP address in the SIP header in order to cause verifying the authority of the SIP client to register the public identity to the IMS based on a reference address in a user database accessible to the IMS.

3. A method according to claim 2, wherein the SBC is configured to include the IP address in the SIP header of said modified registration request only if the SBC detects that the received SIP registration request originates from a broadband subscription.

4. A method according to claim 2, wherein if the SBC is unable to detect whether the received registration request is sent from broadband subscriptions or if the SBC is not configured to attempt said detecting, the SBC responds to received registration requests by sending to the CSCF server a registration request that has the SIP header including the IP address of the SIP client.

5. A method according to claim 2, wherein the method further comprises causing the CSCF server to verify the authority of the SIP client to register the public identity to the IMS based on the reference address.

6. A method according to claim 2, wherein, the IMS further comprises a home subscriber server (HSS) and the method further comprises causing via the CSCF the HSS to verify the authority of the SIP client to register the public identity to the IMS based on a reference address in a user database.

7. A method according to claim 2, wherein the SBC is configured to act as an outbound proxy for the SIP client.

8. A method according to claim 7, wherein the SBC is configured to serve only location-base restricted SIP clients and thereby to always insert the SIP header including the IP address of the SIP client in the SIP registration request.

9. A method according to claim 7, wherein the outbound proxy is configured to operate in a Back-To-Back User Agent (B2BUA) mode.

10. A method according to claim 7, wherein the outbound proxy is configured to send the IP address of the SIP client to the CSCF server in a SIP header added to the registration request.

11. A method according to claim 2, wherein the CSCF server act in one or more of the following functions: a proxy call session control function (P-CSCF) server; serving CSCF (S-CSCF); and an Interrogating CSCF (I-CSCF) server.

12. A method according to claim 2, wherein the user database is selected from a group consisting of: an authentication, authorization, and accounting (AAA) server; and a lightweight directory access protocol (LDAP) server.

13. A method in a call session control function (CSCF) entity for an internet protocol multimedia subsystem (IMS) that comprises a session border controller (SBC) for interacting with session initiation protocol (SIP) clients, each client having an internet protocol address, a private identity and a public identity, the method comprising:
receiving from the SBC a modified SIP registration request indicative of a request of a SIP client to register its public identity to the IMS, the modified SIP registration request indicating the public identity and including the IP address of the SIP client in a SIP header;
identifying the presence of the client's IP address in the SIP header of the modified SIP registration request; and responsive to the identifying of the presence of the client's IP address in the SIP header of the modified SIP registration request:
obtaining the private identity corresponding to the public identity;
causing obtaining of a reference address from a user database based on the private identity; and
causing comparing of said client's IP address with the reference address and if the IP address corresponds to the reference address, proceeding registration of the public identity to the IMS and if the network address does not correspond to the reference address, refusing the registration of the public identity to the IMS.

14. A method according to claim 13, wherein the CSCF server is a serving CSCF (S-CSCF) server configured to obtain the reference address from a home subscriber server (HSS) by sending to the HSS a multimedia authentication request (MAR) indicative of the private identity and of the IP address of the SIP client; and responsively receiving a multimedia authentication answer (MAA) containing the reference address.

15. A method according to claim 13, wherein the CSCF is an interrogating CSCF (I-CSSF) and configured to send to a home subscriber server (HSS) a user authorization request (UAR) including the private identity and the IP address of the client in order to cause the HSS to obtain from the subscriber database a reference address corresponding to the IP address and to compare the reference address to the client's IP address; and responsively to receive from the HSS a rejection message if the IP address does not match with the reference address.

16. A method in a home subscriber server for an internet protocol multimedia subsystem (IMS), comprising:
receiving a user authorization request (UAR) within the IMS indicative of a request of a SIP client to register its public identity to the IMS, the public identity corresponding to a private identity and the UAR including the private identity and an IP address of the SIP client;
identifying the presence of the client's IP address in the UAR;
obtaining the private identity;
obtaining a reference address from a user database based on the private identity; and
comparing said client's IP address with the reference address and if the IP address corresponds to the reference address, proceeding registration of the public identity to the IMS and if the network address does not correspond to the reference address, refusing the registration of the public identity to the IMS.

17. A method according to claim 16, wherein the HSS is configured to receive a registration request from an interrogating CSCF (I-CSCF).

18. A method according to claim 16, wherein the UAR is compliant with Diameter protocol.

19. A method according to claim 16, wherein the HSS is further configured to obtain the reference address from a user database that maintains mapping between allocated addresses and private identities of different SIP clients.

20. An internet protocol multimedia subsystem (IMS) for interacting with session initiation protocol (SIP) clients, wherein each SIP client has an internet protocol (IP) address, private identity and a public identity corresponding to the private identity, the IMS comprising:
a call session control function (CSCF);
a session border controller (SBC) configured to receive a SIP registration request from a SIP client for a given public identity, the registration request comprising the client's IP address and the client's public identity;
the SBC being further configured to:
modify the SIP registration request by adding to the SIP registration request a SIP header comprising the IP address of the SIP client;
send to the CSCF the modified SIP registration request;
the CSCF being configured to:
receive the modified SIP registration request from the SBC;
obtain the private identity and identifying the presence of the SIP header with the client's IP address in the registration request; and
cause, responsive to identifying the presence of the client's IP address in the SIP header of the SIP registration request:
obtaining a reference address from a user database based on the private identity;
comparing said client's IP address with the reference address; and
allowing registration of the public identity to the IMS if the reference address corresponds to the IP address and otherwise refusing the registration.

21. A session border controller (SBC) configured to act as an outbound proxy for an internet protocol multimedia subsystem (IMS), comprising:
an interface configured to interact with session initiation protocol (SIP) clients and with a call session control function (CSCF) server, each of the clients being assigned an internet protocol (IP) address; a private identity; and a public identity;
wherein the interface is further configured to receive a SIP registration request from a SIP client for a given public identity, the registration request comprising the client's IP address and the client's public identity; and
an output for sending to the CSCF server a SIP registration request including the IP address used by SIP client in a SIP header in order to cause verifying the authority of the SIP client to register the public identity to the IMS based on a reference address in a user database accessible to the IMS.

22. An SBC according to claim 21, wherein the SBC is configured to include the IP address in the SIP header of said request only if the SBC detects that the received SIP registration request originates from a broadband subscription.

23. An SBC according to claim 21, wherein the SBC is configured so that if the SBC is unable to detect whether the received registration request is sent from broadband subscriptions or if the SBC is configured not to attempt said detecting, the SBC always responds to received registration requests by sending to the CSCF server a registration request that has the SIP header including the IP address of the SIP client.

24. An SBC according to claim 21, wherein the SCB is further be configured to cause the CSCF server to verify the authority of the SIP client to register the public identity to the IMS based on the reference address.

25. An SBC according to claim 21, wherein the SBC is configured to act as an outbound proxy for the SIP client.

26. An SBC according to claim 21, wherein the SBC is configured to serve only location-base restricted SIP clients and thereby to always insert the SIP header including the IP address of the SIP client in the SIP registration request.

27. An SBC according to claim 21, wherein The SBC is configured to act as an outbound proxy for the SIP client and to serve also other than location-base restricted SIP clients so that the inserting the SIP header including the IP address of the SIP client is configured into the outbound proxy.

28. An SBC according to claim 25, wherein the outbound proxy is configured to operate in a Back-To-Back User Agent (B2BUA) mode.

29. An SBC according to claim 25, wherein the outbound proxy is configured to send the IP address of the SIP client to the CSCF server in the modified SIP registration request only in case that a location-base restriction applies to the SIP client.

30. A call session control function (CSCF) server for an internet protocol multimedia subsystem (IMS) that comprises a session border controller (SBC) for interacting with session initiation protocol (SIP) clients, each client having an internet protocol address, a private identity and a public identity, the CSCF server comprising:
an input configured to receive from the SBC a modified SIP registration request indicative of a request of a SIP client to register its public identity to the IMS, the modified SIP registration request indicating the public identity and including the IP address of the SIP client in a SIP header; and
a processor configured to:
identifying the presence of the client's IP address in the SIP header of the modified SIP registration request; and responsive to the identifying of the presence of the client's IP address in the SIP header of the modified SIP registration request:
obtaining the private identity corresponding to the public identity;
causing obtaining of a reference address from a user database based on the private identity; and
causing comparing of said client's IP address with the reference address and if the IP address corresponds to the reference address, proceeding registration of the public identity to the IMS and if the network address does not correspond to the reference address, refusing the registration of the public identity to the IMS.

31. A CSCF server according to claim 30, wherein the CSCF server is a serving CSCF (S-CSCF) server configured to obtain the reference address from a home subscriber server (HSS) by sending to the HSS a multimedia authentication request (MAR) indicative of the private identity; and responsively receiving a multimedia authentication answer (MAA) containing the reference address.

32. A CSCF server according to claim 30, wherein the CSCF server is configured to operate both as an interrogating CSCF (I-CSCF) and as a serving CSCF (S-CSCF) server.

33. A home subscriber server for an internet protocol multimedia subsystem (IMS), comprising:
an input configured to receive a user authorization request (UAR) within the IMS indicative of a request of a SIP client to register its public identity to the IMS, the public identity corresponding to a private identity and the UAR including the private identity and an IP address of the SIP client;
a processor configured to:
identifying the presence of the client's IP address in the UAR;
obtaining the private identity;
obtaining a reference address from a user database based on the private identity; and
comparing said client's IP address with the reference address and if the IP address corresponds to the reference address, proceeding registration of the public identity to the IMS and if the network address does not correspond to the reference address, refusing the registration of the public identity to the IMS.

34. An HSS according to claim 33, wherein the HSS is configured to receive a registration request from an interrogating CSCF (I-CSCF).

35. An HSS according to claim 33, wherein the UAR is compliant with Diameter protocol.

36. An HSS according to claim 33, wherein the HSS is further configured to obtain the reference address from a user database that maintains mapping between allocated addresses and private identities of different SIP clients.

37. A home subscriber server for an internet protocol multimedia subsystem (IMS) comprising a call session control function (CSCF) server, comprising:
an input configured to receive from the CSCF server a multimedia authorization request (MAR) indicative of a request of a SIP client to register its public identity to the IMS, the public identity corresponding to a private identity and the MAR including the private identity and an IP address of the SIP client;
a processor configured to:
check whether the private identity is associated with a location restriction;
obtain a reference address from a user database based on the private identity responsive to detecting that a location restriction is associated with the private identity; and
send a multimedia authorization answer (MAA) to the CSCF including the reference address corresponding to the private identity.

38. A memory medium storing a computer program configured for controlling a session border controller (SBC) acting as an outbound proxy for an internet protocol multimedia subsystem (IMS), the computer program comprising computer executable program code configured on execution to cause the SBC to:
interact with session initiation protocol (SIP) clients and with a call session control function (CSCF) server, each of the clients being assigned an internet protocol (IP) address; a private identity; and a public identity;
receive a SIP registration request from a SIP client for a given public identity, the registration request comprising the client's IP address and the client's public identity;
modify the SIP registration request to include the IP address of the SIP client in a SIP header; and
send to the CSCF server the modified SIP registration request including the IP address in the SIP header in order to cause verifying the authority of the SIP client to register the public identity to the IMS based on a reference address in a user database accessible to the IMS.

39. A memory medium storing a computer program configured for controlling a a call session control function (CSCF) entity for an internet protocol multimedia subsystem (IMS) that comprises a session border controller (SBC) for interacting with session initiation protocol (SIP) clients, each client having an internet protocol address, a private identity and a public identity, wherein the program comprises computer executable program code configured on execution to cause the CSCF to:
receive from the SBC a modified SIP registration request indicative of a request of a SIP client to register its public identity to the IMS, the modified SIP registration request indicating the public identity and including the IP address of the SIP client in a SIP header;
identify the presence of the client's IP address in the SIP header of the modified SIP registration request; and responsive to the identifying of the presence of the client's IP address in the SIP header of the modified SIP registration request:
obtain the private identity corresponding to the public identity;
cause obtaining of a reference address from a user database based on the private identity; and
cause comparing of said client's IP address with the reference address and if the IP address corresponds to the reference address, to proceed registration of the public identity to the IMS and if the network address does not correspond to the reference address, to refuse the registration of the public identity to the IMS.

40. A memory medium storing a computer program configured to control a home subscriber server (HSS) for an internet protocol multimedia subsystem (IMS), the computer program comprising computer executable program code configured on execution to cause the HSS to:
receive a user authorization request (UAR) within the IMS indicative of a request of a SIP client to register its public identity to the IMS, the public identity corresponding to a private identity and the UAR including the private identity and an IP address of the SIP client;
identify the presence of the client's IP address in the UAR;
obtain the private identity;
obtain a reference address from a user database based on the private identity; and
compare said client's IP address with the reference address and if the IP address corresponds to the reference address, to proceed registration of the public identity to the IMS and if the network address does not correspond to the reference address, to refuse the registration of the public identity to the IMS.

41. A session border controller (SBC) configured to act as an outbound proxy for an internet protocol multimedia subsystem (IMS), comprising:
means for interacting with session initiation protocol (SIP) clients and with a call session control function (CSCF) server, each of the clients being assigned an internet protocol (IP) address; a private identity; and a public identity;
means for receiving a SIP registration request from a SIP client for a given public identity, the registration request comprising the client's IP address and the client's public identity; and
means for sending to the CSCF server a SIP registration request including the IP address used by SIP client in a SIP header in order to cause verifying the authority of the SIP client to register the public identity to the IMS based on a reference address in a user database accessible to the IMS.
